(19) United States
(12) Patent Application Publication
(10) Pub. No.: US 2006/0045976 A1
(43) Pub. Date: Mar. 2, 2006

(54) Coil part and method of producing the same

(76) Inventors: Hideaki Nakayama, Izushi (JP); Toshiyuki Seo, Kinosaki (JP); Hiromasa Yamamoto, Toyonaka (JP); Toshihiro Yoshizawa, Higashiosaka (JP); Akira Fujimori, Toyooka (JP); Toyonori Kanetaka, Toyooka (JP)

Correspondence Address: WENDEROTH, LIND & PONACK, L.L.P., 2033 K STREET N. W., SUITE 800, WASHINGTON, DC, 20006-1021, US

(21) Appl. No.: 10/522,143

(22) PCT Filed: Aug. 1, 2003
(86) PCT No.: PCT/JP03/09792

§ 371 Date: Jan. 24, 2005

(30) Foreign Application Priority Data
Aug. 5, 2002 (JP) 2002-227124
Aug. 5, 2002 (JP) 2002-227125

(51) Int. Cl. H01F 17/02; H01F 27/29; H01F 41/04

(52) U.S. Cl. 427/372.2; 427/402; 148/516; 428/209

(57) ABSTRACT

A coil component of the present invention has prismatic base body (1), copper plated layer (2) formed on the outer periphery of base body (1), coil section (3) that is formed by spirally grooving copper plated layer (2) and has linear section (3a) and groove (3b), exterior section (8) formed on coil section (3), and electrode section (9). Insulating coating layer (4) is disposed between copper plated layer (2) formed on the outer periphery of longitudinal section (1a) of base body (1) and exterior section (8). The copper plated layer of the coil section can be suppressed from being exposed at the surface of exterior section (8).

### TECHNICAL FIELD

The present invention relates to a coil component for use in various electronic instruments.

### BACKGROUND ART

A conventional coil component and a method of manufacturing it will be hereinafter described with reference to the drawings.

As shown in FIG. 8 and FIG. 9, the conventional coil component has the following elements:
base body 17;
copper plated layer 18 formed on the entire outer periphery of base body 17;
coil section 19 formed by spirally grooving a longitudinal part of copper plated layer 18;
exterior section 23 formed on the outer periphery of coil section 19; and
electrode sections 24 formed at ends of base body 17 so as to cover the ends of exterior section 23.
   Exterior section 23 has the following elements:
uncured resin layer 21 composed of liquid epoxy resin containing no curing agent, aluminum hydroxide, silica, and ethanol; and
powder resin layer 22 composed of powder epoxy resin containing a curing agent, mica, carbon, and silica.
   Electrode section 24 has conductive resin, nickel plating, and tin plating.

FIG. 10A to FIG. 10I show a manufacturing method of the coil component. The manufacturing method has the following processes:
a copper plating process of forming copper plated layer 18 on base body 17 (FIG. 10A);
a coil section forming process of forming coil section 19 by spirally grooving a longitudinal part of copper plated layer 18 with a laser (FIG. 10B);
an etching process of removing copper chips 25 produced by the laser in the coil section forming process (FIG. 10C);
an uncured resin applying process of forming uncured resin layer 21 by dipping base body 17 including coil section 19 into uncured resin and then colliding micro iron balls 26, to which the uncured resin is adhered, with base body 17 (FIG. 10D);
a powder resin applying process of forming powder resin layer 22 around uncured resin layer 21 (FIG. 10E);
a resin curing process of scattering base body 17 on a sheet impregnated with fluorocarbon resin and curing powder resin with a dryer (FIG. 10F);
an end surface treating process of peeling resin away from an end surface (FIG. 10G);
an electrode forming process of forming electrodes made of conductive resin at ends of base body 17 so as to cover an end surface of powder resin layer 22 (FIG. 10H); and
an electrode plating process of forming electrode sections 24 by plating the electrodes (FIG. 10I).

In such a coil component, generally, length, width, and depth of the spirally formed groove are varied for obtaining a desired inductance, so that the groove volume is varied. When the desired inductance is reduced, the length of the groove is reduced but the volume is increased.

FIG. 11A and FIG. 11B show results obtained by measuring thicknesses at three points of the exterior section of each of five arbitrary coil components. W1max, W1min, and W2 denote maximum thickness and minimum thickness of a flat section of exterior section 23 of each of samples 1 to 5, and thickness of a corner of exterior section 23, respectively. In either of a coil section having large groove volume and low inductance and a coil section having small groove volume and high inductance, thicknesses of exterior section 23 formed on coil section 19 are largely dependent on measured places. In other words, variations in W1max and W1min are extremely significant, and W2 is extremely small. A recessed part affected by the groove is formed in the surface of exterior section 23.

In the coil component having the conventional structure, the outside dimension is 1.0 mm square or less, namely extremely small. In this coil component, thickness of exterior section 23 is extremely small, and the thickness is apt to become uneven in the corners and flat parts of exterior section 23. Especially, when the thickness is uneven, copper plated layer 18 of the coil section is disadvantageously exposed at the surface of exterior section 23.

### SUMMARY OF THE INVENTION

The present invention addresses the problems and aims to provide a coil component that suppresses the copper plated layer of the coil section from being exposed at the surface of the exterior section and a method of manufacturing the coil component. This coil component has a structure where the exterior section is formed by alternately stacking first resin layers and second resin layers.

The thickness of the exterior section can be even by adjusting the number of alternate stackings of the first resin layers and second resin layers. Especially, the coil section has a groove, so that the exterior section partially caves in. Thus, recessed parts may be formed in the surface of the exterior section, and evenness of the surface may be difficult to obtain. Alternately stacking the first resin layers and second resin layers as shown in the present invention can suppress the recessed parts from being formed in the surface of the exterior section.

### BRIEF DESCRIPTION OF THE DRAWINGS

FIG. 1 is a front sectional view of a coil component in accordance with an exemplary embodiment of the present invention.

FIG. 2 is a side sectional view of the coil component in accordance with the exemplary embodiment.

FIG. 3 is an enlarged sectional view of part A (a proximity of the groove in the coil section) of the coil component in accordance with the exemplary embodiment illustrated in FIG. 1.

FIG. 4A shows a copper plating process.

FIG. 4B shows a coil section forming process.

FIG. 4C shows an etching process.

FIG. 4D shows an insulating coating forming process.

FIG. 4E shows an uncured resin applying process.

FIG. 4F shows a powder resin applying process.

FIG. 4G shows a resin curing process.

FIG. 4H shows an end surface treating process.

FIG. 4I shows an electrode forming process.

FIG. 4J shows an electrode plating process.

FIG. 5 is a front sectional view of another coil component.

FIG. 6 is an enlarged sectional view of part A (a proximity of the groove in the coil section) of the coil component illustrated in FIG. 5.

FIG. 7A is a comparative diagram showing thickness of the exterior section of another coil component (low inductance).

FIG. 7B is a comparative diagram showing thickness of the exterior section of the coil component (high inductance).

FIG. 8 is a front sectional view of a conventional coil component.

FIG. 9 is an enlarged sectional view of part B proximity of the groove in the coil section) of the conventional coil component illustrated in FIG. 8.

FIG. 10A shows a copper plating process.

FIG. 10B shows a coil section forming process.

FIG. 10C shows an etching process.

FIG. 10D shows an uncured resin applying process.

FIG. 10E shows a powder resin applying process.

FIG. 10F shows a resin curing process.

FIG. 10G shows an end surface treating process.

FIG. 10H shows an electrode forming process.

FIG. 10I shows an electrode plating process.

FIG. 11A is a comparative diagram showing thickness of the exterior section of the conventional coil component (low inductance).

FIG. 11B is a comparative diagram showing thickness of the exterior section of the conventional coil component (high inductance).

FIG. 12 is a perspective view showing the appearance of the coil component.

### DETAILED DESCRIPTION OF PREFERRED EMBODIMENTS

### Exemplary Embodiment

A coil component in accordance with an exemplary embodiment of the present invention will be described hereinafter with reference to the following drawings.

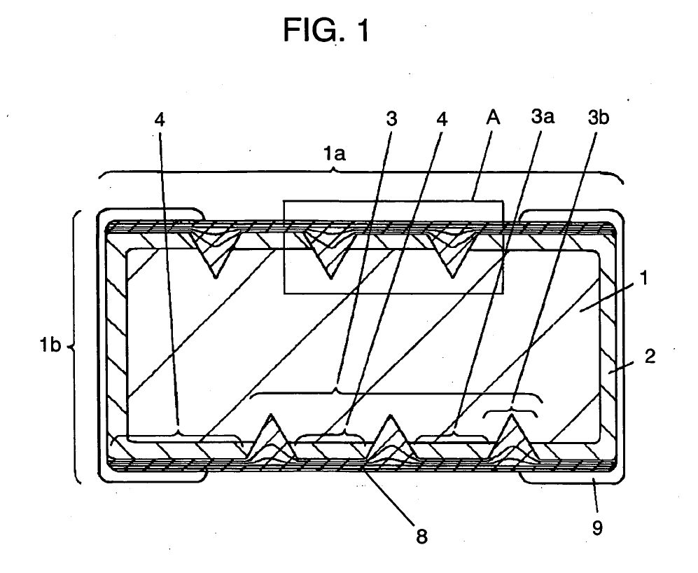

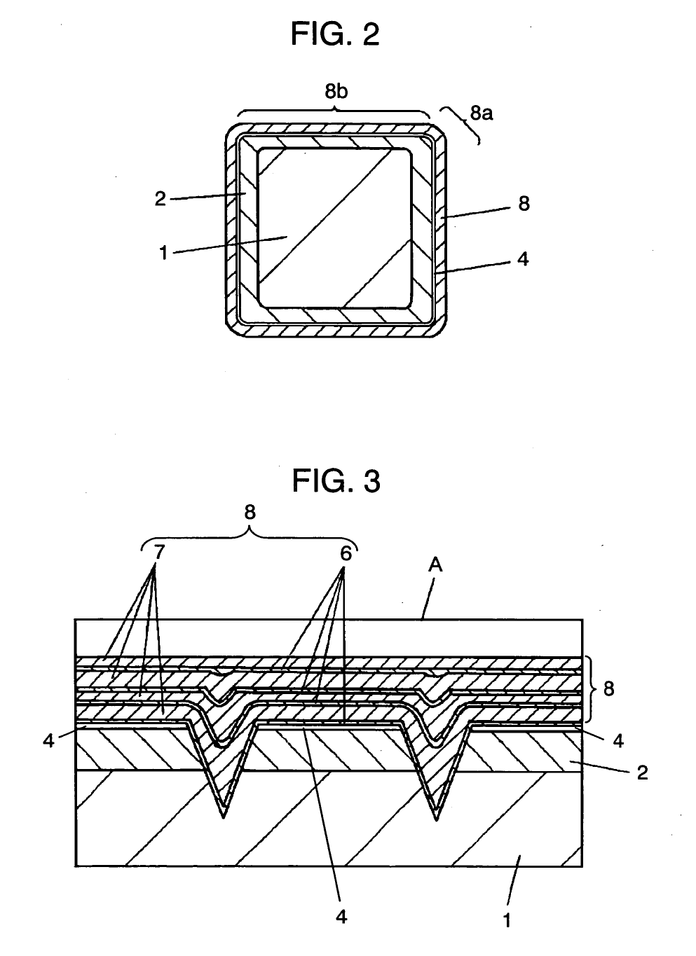

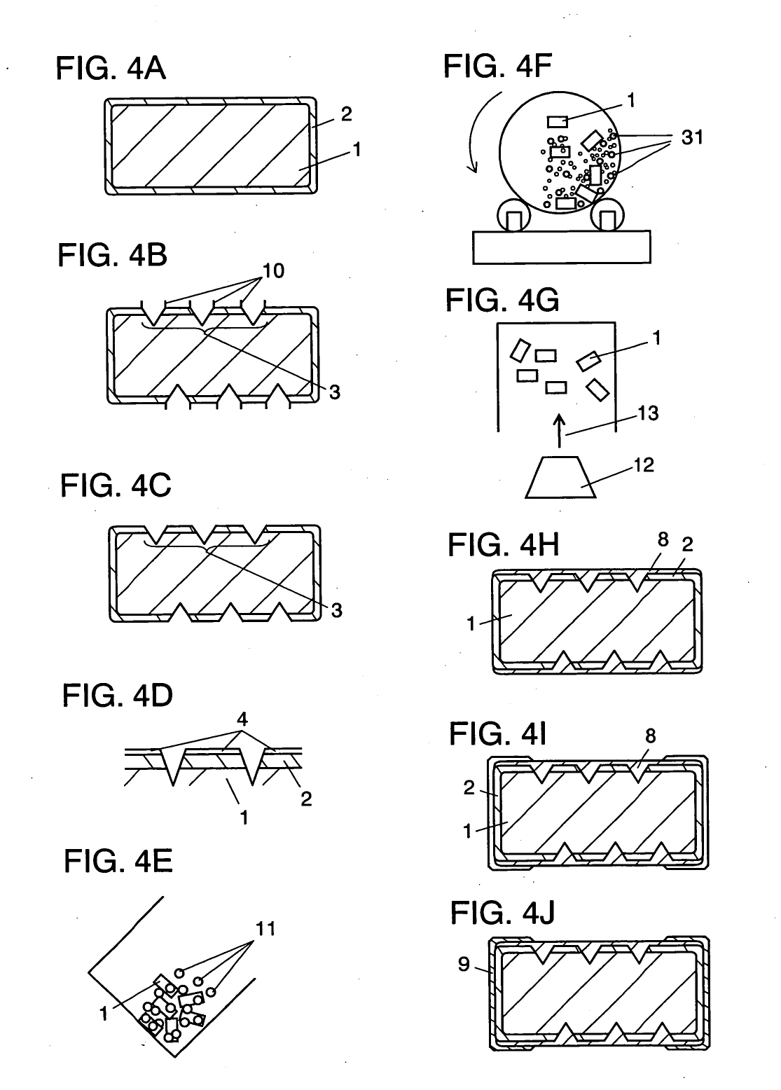

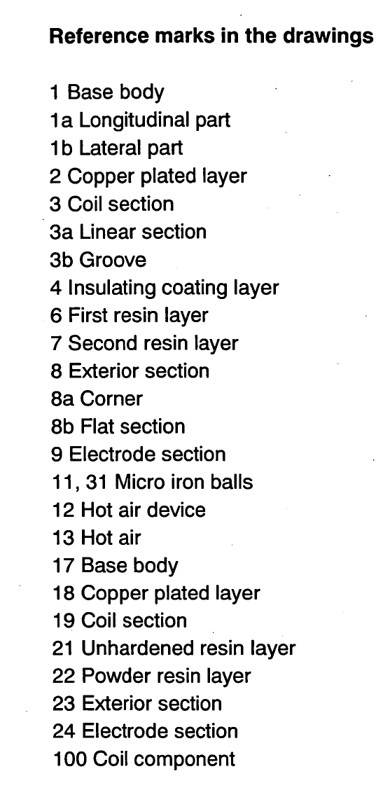

FIG. 1 is a front sectional view of the coil component in accordance with the exemplary embodiment of the present invention. FIG. 2 is a side sectional view of the coil component. FIG. 3 is an enlarged sectional view of proximity of the groove in the coil section of the coil component. FIG. 4A to FIG. 4J show manufacturing processes of the coil component. As shown in FIG. 12, the X-axis direction of coil component 100 is called the longitudinal direction, and the Z-axis direction is called the lateral direction. The XZ surface is called a front surface, and the YZ surface is called a side surface.

As shown in FIG. 1 to FIG. 3, the coil component of the exemplary embodiment of the present invention has the following elements:
prismatic base body 1;
copper plated layer 2 formed on the entire outer periphery of base body 1;
coil section 3 that is formed by spirally grooving copper plated layer 2 formed on the outer periphery of longitudinal part 1a of base body 1 and has linear section 3a and groove 3b;
exterior section 8 formed on coil section 3 by alternately stacking three or more first resin layers 6 and three or more second resin layers 7; and
electrode sections 9 formed on copper plated layer 2 positioned at end surfaces of lateral parts 1b of base body 1.

Insulating coating layer 4 made of imidazole compound is disposed between copper plated layer 2 positioned on the outer periphery of longitudinal section 1a of base body 1 and exterior section 8.

Insulating coating layer 4 is a coating made of imidazole compound formed on the surface of the copper and has solder heat resistance. Here, the imidazole compound is imidazole derivative of allylimidazole compound, alkylimidazole compound, and benzimidazole compound. Solution of these compounds is applied to a desired part of the copper plated layer, then washed, and dried, thereby accurately forming chemical coating on the desired part.

The lowest layer of exterior section 8 is formed of first resin layer 6, and the uppermost layer thereof is formed of second resin layer 7. Here, the lowest layer indicates a layer firstly formed on coil section 3 in the exterior section.

First resin layer 6 is made of first composition of liquid epoxy resin containing no curing agent, aluminum hydroxide, silica, reactive diluents, and isopropyl alcohol. Second resin layer 7 is made of second composition of powder epoxy resin containing a curing agent, mica, carbon, and silica.

Electrode sections 9 are made of conductive resin, nickel plating, and tin plating, and are formed so as to cover end surfaces of lateral parts 1b of base body 1 and the ends of exterior section 8.

A method of manufacturing such a coil component is described hereinafter with reference to FIG. 4A to FIG. 4J.

First, copper plated layer 2 is formed on the entire outer periphery of prismatic base body 1 (copper plating process) (FIG. 4A).

Second, the copper plated layer formed on the outer periphery of longitudinal part 1a of base body 1 is spirally grooved by a laser to form coil section 3 including linear section 3a and groove 3b (coil section forming process) (FIG. 4B).

Third, copper chips 10 produced by the laser processing in the coil section forming process (FIG. 4B) are removed (etching process) (FIG. 4C).

Fourth, insulating coating layer 4 is formed on copper plated layer 2 formed on the outer periphery of longitudinal part 1a of base body 1 (insulating coating forming process) (FIG. 4D).

Fifth, exterior section 8 is formed on coil section 3 having insulating coating layer 4 by alternately stacking first resin layers 6 and second resin layers 7 (exterior section forming process).

This exterior section forming process has a first resin layer forming process (FIG. 4E), a second resin layer forming process (FIG. 4F), and a resin curing process (FIG. 4G).

In the first resin layer coating process, a plurality of micro iron balls 11 onto which the first composition of liquid epoxy resin, aluminum hydroxide, silica, reactive diluents, and isopropyl alcohol is adhered are collided with base body 1 having coil section 3, and first resin lying on micro iron balls 11 is transferred to base body 1 (FIG. 4E).

An ultrasonic homogenizer is used for stirring and blending the materials of the first composition. Thus, even when a plurality of micro aluminum hydroxide particles agglomerate into a lump, the lump can be dispersed. A projection can be therefore prevented from occurring on exterior section 8. A commercial ultrasonic washer can be used as the ultrasonic homogenizer, so that the effect discussed above can be obtained using an inexpensive facility.

In the second resin layer forming process, a plurality of micro iron balls 31 are collided with base body 1 having coil section 3, the second composition is pressed between the surfaces of micro iron balls 31 and base body 1 to adhere the second composition to base body 1, in a vessel having the second composition of powder epoxy resin, mica, carbon, and silica (FIG. 4F). At this time, part of the first resin is taken into the second resin. When the amount of mica is large, the surface of second resin layer 7 is not even. When the amount of mica is small, base body 1 sticks to another base body 1 via second resin layer 7. Therefore, it is preferable that the amount of mica is 28% to 32%.

Finally, in a resin curing process, base body 1 on which first resin layers 6 and second resin layers 7 are alternately stacked is floated in the air and dried by hot air 13 supplied from hot air device 12, thereby curing second resin layers 7 (FIG. 4G).

Exterior section 8 having stacked first resin layers 6 and second resin layers 7 is formed by repeating the first resin layer forming process, second resin layer forming process, and resin curing process. Exterior section 8 is formed so that the lowest layer is formed of first resin layer 6 and the uppermost layer is formed of second resin layer 7.

Sixth, electrode sections 9 are formed on copper plated layer 2 positioned at both end surfaces of lateral parts 1b of base body 1 (electrode section forming process).

The electrode section forming process has an end surface treating process, an electrode forming process, and an electrode plating process. In end surface treating process, part of exterior section 8 adhered onto copper plated layer 2 on the end surfaces of lateral parts 1b of base body 1 in the exterior section forming process is peeled (FIG. 4H). In the electrode forming process, conductive resin is then formed so as to cover the end surfaces to the ends of exterior section 8 (FIG. 4I). In the electrode plating process, the formed conductive resin is nickel-plated and tin-plated (FIG. 4J).

The coil component having the structure discussed above has insulating coating layer 4 between copper plated layer 2 and exterior section 8, so that copper plated layer 2 can be suppressed from being exposed at the surface of exterior section 8 even when the thickness of exterior section 8 becomes uneven. Insulating coating layer 4 is a coating made of imidazole compound formed on the surface of the copper, and insulating coating layer 4 having solder heat resistance can be appropriately formed.

An air bubble may occur in forming exterior section 8. Even when a pin hole or the like occurs in exterior section 8 due to the air bubble, copper plated layer 2 can be suppressed from being exposed at the surface of exterior section 8 thanks to insulating coating layer 4.

In the present embodiment, a function as exterior section 8 is obtained because the lowest layer of exterior section 8 is formed of first resin layer 6 and the uppermost layer is formed of second resin layer 7.

Especially, thicknesses of corners 8a and flat sections 8b of exterior section 8 can be made homogeneous while an appropriate thickness as exterior section 8 is being secured. That is because first resin layer 6 is made of first composition of liquid epoxy resin containing no curing agent, aluminum hydroxide, silica, reactive diluents, and isopropyl alcohol, and second resin layer 7 is made of second composition of powder epoxy resin containing a curing agent, mica, carbon, and silica.

In the conventional method of forming exterior section 8 on prismatic base body 1 using insulating resin, thicknesses of corners 8a and flat sections 8b of exterior section 8 are apt to differ from each other. When insulating resin having high viscosity is used, flat sections 8b project due to surface tension and become thicker than corners 8a. When insulating resin having low viscosity is used, the appropriate thickness as exterior section 8 cannot be secured. These problems can be solved using the manufacturing method of the present embodiment.

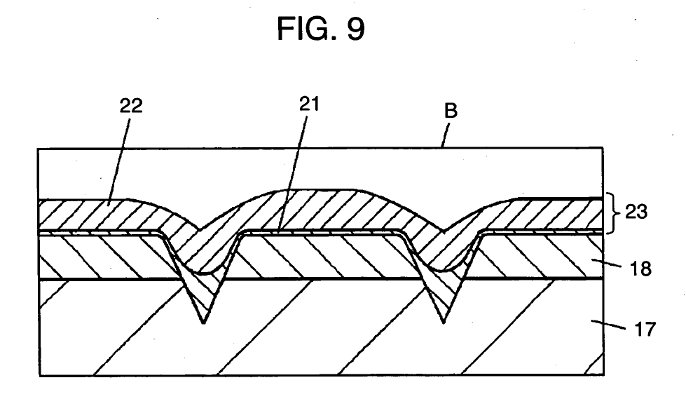

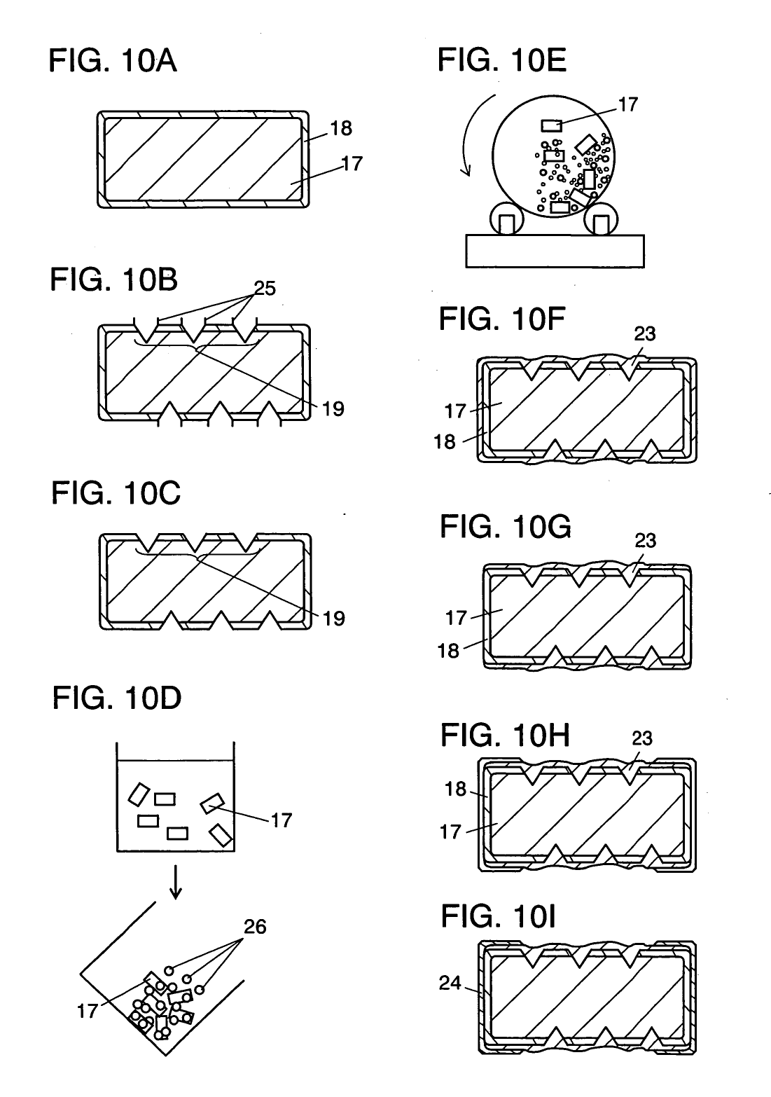

If exterior section 23 is formed on coil section 3 by the conventional method as shown in FIG. 8 or FIG. 9, exterior section 23 may partially cave in on groove 3b in coil section 3. Thus, recessed parts affected by the caving may be formed in the surface of exterior section 23, and evenness of the surface of exterior section 23 may be damaged. While, in the manufacturing method of the present embodiment, exterior section 8 is formed by alternately stacking first resin layers 6 and second resin layers 7, so that adjusting the number of stackings so as to provide a desired exterior thickness can suppress the forming of the recessed parts in the surface of exterior section 8.

Electrode section 9 is formed of conductive resin, nickel plating, tin plating in the present embodiment, so that conductivity is also improved.

In the manufacturing method of the present invention, a coil component having the special advantage of the present invention can be manufactured.

In the manufacturing method of the present invention, a plurality of micro iron balls 11 having uncured resin on their surfaces are collided with base body 1 having coil section 3, and the uncured resin on micro iron balls 11 is transferred to base body 1 in the exterior section forming process. Therefore, first resin layer 6 can be appropriately formed on the coil section.

The exterior section forming process has the first resin layer forming process, second resin layer forming process, and resin curing process. In the second resin layer forming process, a plurality of micro iron balls 31 are collided with base body 1 having coil section 3, the second composition is pressed between the surfaces of micro iron balls 31 and base body 1 to adhere the second composition to base body 1, in a vessel having the second composition of powder epoxy resin. Therefore, second resin layers 7 can be appropriately formed.

In the resin curing process, first resin layers 6 and second resin layers 7 are alternately stacked on coil section 3, and then base body 1 having first resin layers 6 and second resin layers 7 alternately stacked on coil section 3 is floated in the air and dried to cure second resin layers 7. Therefore, coil components do not stick to each other and powder resin can be appropriately cured.

Insulating coating layer 4 is disposed between copper plated layer 2 and exterior section 8 in the present embodiment of the present invention, so that copper plated layer 2 can be prevented from being exposed at the surface of exterior section 8 even if the thickness of exterior section 8 may be uneven.

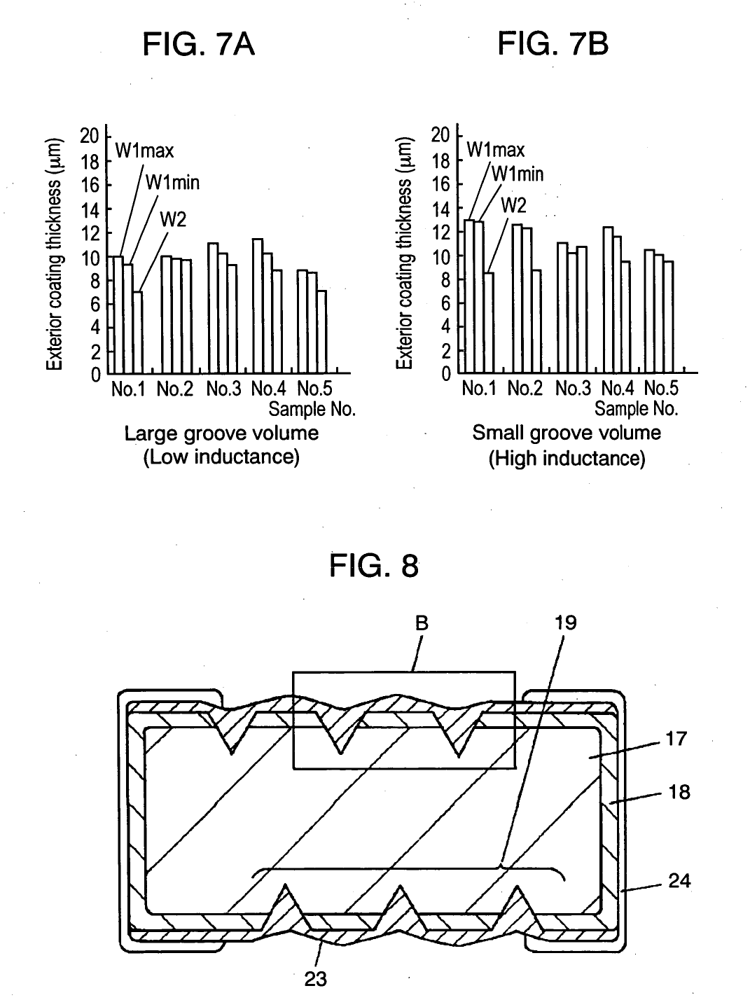

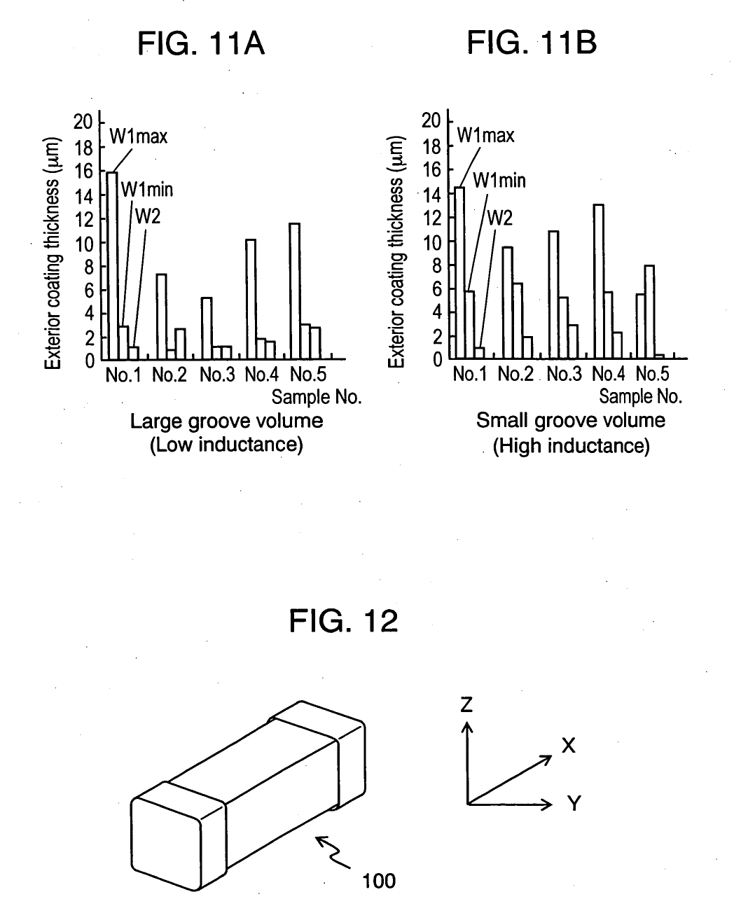

FIG. 7A and FIG. 7B show results obtained by extracting five arbitrary coil components of the present embodiment and measuring thicknesses at three points of the exterior section of each coil component. W1max, W1min, and W2 denote maximum thickness and minimum thickness of a flat section of exterior section 8 of each of samples 1 to 5, and thickness of a corner of exterior section 8, respectively. According to FIG. 7A and FIG. 7B, in either of a low inductance case where the volume of groove 3b is large and a high inductance case where the volume of groove 3b is small, thicknesses of exterior section 8 are substantially constant. Comparing five arbitrary coil components, namely samples 1 to 5, the maximum thickness (W1max) and minimum thickness (W1min) of flat section 8b of exterior section 8 of each coil component are extremely close to each other, and the thickness of corner 8a (W2) is close to them. These results noticeably show improvement of evenness of the exterior section comparing with FIG. 11A and FIG. 11B. Here, FIG. 11A and FIG. 11B show the results obtained when the exterior section is formed by the conventional method.

Exterior section 8 of the present embodiment has first resin layer 6 as the lowest layer and second resin layer 7 as the uppermost layer.

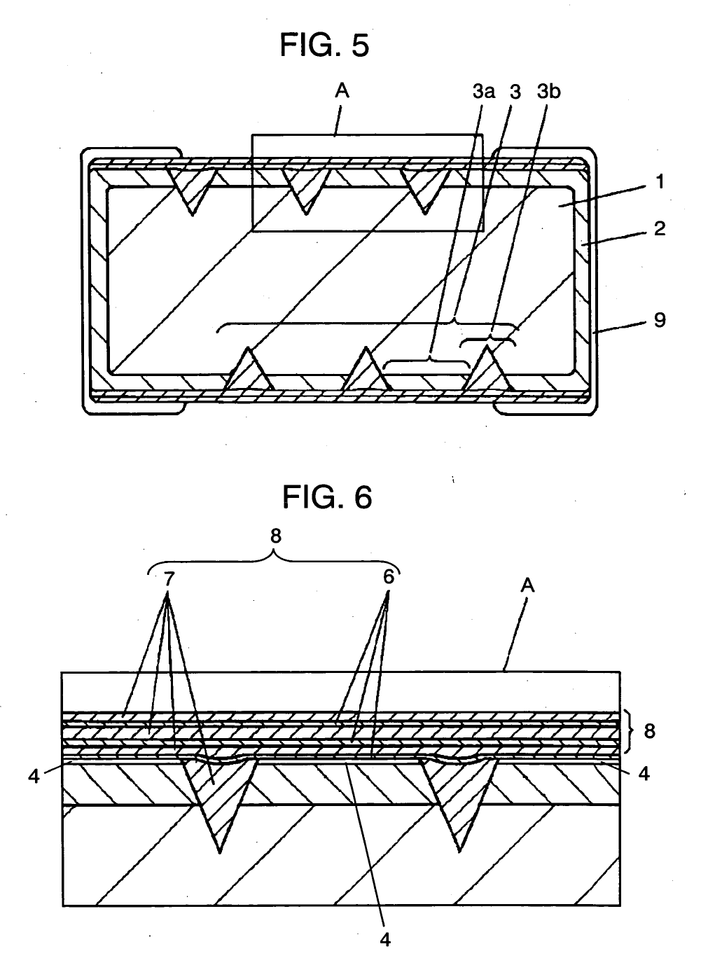

Next, FIG. 5 and FIG. 6 show another embodiment. In this embodiment, the lowest layer and uppermost layer are formed of second resin layers 7, and second resin layer 7 as the lowest layer is formed only in groove 3b in coil section 3. In this case, first resin layer 6 formed on second resin layer 7 as the lowest layer formed only in coil section 3 does not cave in on groove 3b in coil section 3, and the surface of coil section 3 is flat. Therefore, a recessed part can be suppressed from occurring in the surface of exterior section 8 formed on coil section 3.

Second resin layer 7 can be easily formed only in groove 3b in response to volume change of groove 3b regardless of length, width, and depth of groove 3b in coil section 3. Thicknesses of first resin layers 6 and second resin layers 7 alternately formed on coil section 3 can be also made even.

In the resin curing process, base body 1 having first resin layers 6 and second resin layers 7 alternately stacked on coil section 3 may be disposed in a hole guide formed on a sheet impregnated with fluorocarbon resin and dried to cure second resin layers 7. In this case, a similar advantage is also produced.

### INDUSTRIAL APPLICABILITY

The present invention can provide a coil component having an insulating coating layer between a copper plated layer and an exterior section, and a manufacturing method of the coil component. Even when the thickness of the exterior section becomes uneven, the insulating coating layer can suppress the copper plated layer from being exposed at the surface of the exterior section.

Even when an air bubble occurs in forming the exterior section and produces a pin hole or the like in the exterior section, the copper plated layer can be also suppressed from being exposed at the surface of the exterior section.

1. A coil component comprising:
prismatic base body (1);
coil section (3) formed of a copper plated layer spirally formed on an outer periphery of a longitudinal side surface of the base body;
exterior section (8) for covering the coil section; and
electrode section (9) formed on an end surface in a lateral part of the base body and connected to the coil section,
wherein
the coil section is formed by grooving the copper plated layer previously formed on an entire side surface of the base body and removing the copper plated layer from the groove, and
the exterior section includes alternately stacked first resin layers and second resin layers.

2. The coil component according to claim 1, wherein
the first resin layer contains liquid epoxy resin, aluminum hydroxide, silica, reactive diluents, and
second resin layer contains powder epoxy resin, curing agent, mica, carbon, and silica.

3. The coil component according to claim 1,
wherein the exterior section is formed by alternately stacking the uncured first resin layers and the uncured second resin layers and curing the first and second resin layers.

4. The coil component according to claim 1,
wherein the first resin layer is adjacent to the copper plated layer and the second resin layer is the outermost layer in the exterior section.

5. The coil component according to claim 1, further comprising the first resin layer only in the groove,
wherein the coil section is flattened by filling the groove with the first resin layer.

6. The coil component according to claim 1, further comprising an insulating coating between the copper plated layer of the coil section and the first resin layer.

7. The coil component according to claim 1, further comprising the copper plated layer on an end surface of a lateral part of the base body,
wherein the electrode section formed on the copper plated layer includes a conductive resin layer, a nickel plated layer, and a tin plated layer.

8. A manufacturing method of a coil component comprising:
forming a copper plated layer on an entire outer periphery of a prismatic base body;
forming a coil section including a linear section and a groove by spirally grooving the copper plated layer formed on the outer periphery of a longitudinal part of the base body;
forming an exterior section on the coil section; and
forming an electrode section on the copper plated layer formed on an end surface of a lateral part of the base body,
wherein the forming step of the exterior section alternately comprises steps of forming an uncured first resin layer on the coil section and steps of forming an uncured second resin layer on the coil section.

9. The manufacturing method according to claim 8, wherein
the uncured first resin layer is made of first composition of liquid epoxy resin containing no curing agent, aluminum hydroxide, silica, reactive diluents, and isopropyl alcohol, and
the uncured second resin layer is made of second composition of powder epoxy resin, curing agent, mica, carbon, and silica.

10. The manufacturing method according to claim 9, wherein
the step of forming the exterior section includes a step of forming a first resin layer, and
in the step of forming the first resin layer, a plurality of micro iron balls onto which the uncured first resin layer is adhered are collided with the base body having the coil section, and the uncured first resin layer adhered onto the micro iron balls is transferred to the base body.

11. The manufacturing method according to claim 9, wherein
the step of forming the exterior section includes a step of forming a second resin layer, and
in the step of forming the second resin layer, a plurality of micro iron balls are collided with the base body having the coil section, and the powder resin is pressed between surfaces of the micro iron balls and the base body to adhere the uncured second resin layer to the base body, in a vessel containing the second composition.

12. The manufacturing method according to claim 10, wherein
the step of forming the exterior section includes a step of forming a second resin layer after the step of forming the first resin layer, and
in the step of forming the second resin layer, a plurality of micro iron balls are collided with the base body, and the uncured second resin layer is adhered to a surface of the base body having the uncured first resin layer, in a vessel containing the second composition.

13. The manufacturing method according to claim 12, wherein
the step of forming the exterior section further includes a step of curing resin, and
in the step of curing resin, the step of forming the first resin layer and the step of forming the second resin layer are alternately repeated at a plurality of times, and the base body is then floated in an air, dried, and heat-cured.

14. The manufacturing method according to claim 12, wherein
the step of forming the exterior section further includes a step of curing resin, and
in the step of curing resin, the step of forming the first resin layer and the step of forming the second resin layer are alternately repeated at a plurality of times, and the base body is disposed in a hole guide formed on a sheet impregnated with fluorocarbon resin, dried, and heat-cured.

15. The manufacturing method according to claim 8,
wherein the step of forming the exterior section includes the step of forming the first resin layer firstly and the step of forming the second resin layer finally.

16. The manufacturing method according to claim 8,
wherein the step of forming the exterior section further includes a step of previously forming the second resin layer only in the groove.

17. The manufacturing method according to claim 8, further comprising a step of forming an insulating coating layer between the copper plated layer formed on the outer periphery of the longitudinal part of the base body and the exterior section, the step of forming the insulating coating layer being performed between the step of forming the coil section and the step of forming the exterior section.

18. The manufacturing method according to claim 9, further comprising a step of blending and dispersing the first composition using ultrasonic wave.

19. The manufacturing method according to claim 8,
wherein the step of forming the electrode section includes a step of forming a conductive resin layer, a step of nickel plating, and a step of tin plating.
